(19) United States
(12) Patent Application Publication
(10) Pub. No.: US 2026/0215994 A1
(43) Pub. Date: Jul. 30, 2026

(54) COSMETIC PROCEDURE DEVICE AND COSMETIC PROCEDURE METHOD

(71) Applicant: APR CO., LTD., Seoul (KR)

(72) Inventors: Jong Chul Ji, Seoul (KR); Gyoun Jung Lee, Seoul (KR); Seung Woo Park, Seoul (KR)

(73) Assignee: APR CO., LTD., Seoul (KR)

(21) Appl. No.: 19/140,912

(22) PCT Filed: Dec. 7, 2023
(86) PCT No.: PCT/KR2023/020125

§ 371 Date: Jun. 18, 2025

(30) Foreign Application Priority Data
Dec. 19, 2022 (KR) 10-2022-0178397

(51) Int. Cl. A61H 9/00

(52) U.S. Cl. CPC A61H 9/0057; A61H 2201/0153; A61H 2201/5007; A61H 2201/5058

(57) ABSTRACT

A beauty treatment device is provided. A beaty treatment device according to one aspect of the present invention includes a main body; a head including a body portion that protrudes outwardly from the main body and a contact portion that is provided at an end portion of the body portion so as to come into contact with a skin and has a suction port formed therein; a negative pressure application module that is provided inside the main body so as to apply a negative pressure for elevating a treatment area of the skin to the suction port; a height measurement sensor that measures a height of the treatment area elevated by the negative pressure; and a controller that is electrically connected to the negative pressure application module and the height measurement sensor, in which the controller controls the negative pressure application module so that a first negative pressure is applied to the suction port, and controls the negative pressure application module so that a second negative pressure determined based on a first measurement height of the treatment area elevated by the first negative pressure is applied to the suction port.

### TECHNICAL FIELD

The present invention relates to a beauty treatment device and a beauty treatment method, and more specifically, to a beauty treatment device and a beauty treatment method for suctioning a portion of a skin.

### BACKGROUND ART

In recent years, the spread of home beauty treatment devices that allow users to perform beauty treatments such as hair removal and skin care at home has been increasing. The home beauty treatment devices lower the barrier to beauty treatment and increase accessibility by allowing users to perform beauty treatments conveniently at their own home at their own desired time.

For example, recently, home beauty treatment devices have been developed that perform massages, or the like by elevating the skin up by suction, or the like, and at the same time, perform hair removal, massage, or skin care by irradiating the elevated part of the skin with a laser.

As the spread of these home beauty treatment devices increases, the performance of home beauty treatment devices is also improving dramatically compared to the past, and the effectiveness of the treatment is also increasing. This means that the possibility of side effects occurring while the user is performing beauty treatment using the device is also increasing.

Therefore, in order to obtain the effect of using a home beauty treatment device safely and effectively without side effects, suction should be performed appropriately. However, conventional beauty treatment devices have a problem in that the user suddenly applies a certain amount of negative pressure to the skin of the user without considering the characteristics of each user or the characteristics of the body part being used even when the required suction intensity varies depending on the above-described characteristics, which causes side effects such as skin damage, or the beauty effect according to suction is not sufficiently achieved.

### DISCLOSURE

### Technical Problem

The present invention has been made in consideration of the above-described matters, and an object of the present invention is to provide a beauty treatment device and a beauty treatment method capable of providing a beauty treatment effect by suctioning and elevating the skin.

Another object of the present invention is to provide a beauty treatment device and a beauty treatment method capable of minimizing side effects due to skin suction while maximizing the beauty treatment effect accordingly.

Still another object of the present invention is to provide a beauty treatment device and a beauty treatment method capable of elevating a treatment area to a target height without causing sudden deformation of the skin.

Objects of the present invention are not limited to the objects mentioned above, and other objects not mentioned will be clearly understood by those skilled in the art to which the present invention belongs from the description below.

### Technical Solution

According to one aspect of the present invention, there is provided a beauty treatment device including: a main body; a head including a body portion that protrudes outwardly from the main body and a contact portion that is provided at an end portion of the body portion so as to come into contact with a skin and has a suction port formed therein; a negative pressure application module that is provided inside the main body so as to apply a negative pressure for elevating a treatment area of the skin to the suction port; a height measurement sensor that measures a height of the treatment area elevated by the negative pressure; and a controller that is electrically connected to the negative pressure application module and the height measurement sensor, in which the controller controls the negative pressure application module so that a first negative pressure is applied to the suction port, and controls the negative pressure application module so that a second negative pressure determined based on a first measurement height of the treatment area elevated by the first negative pressure is applied to the suction port.

In this case, the controller may be configured to determine a final target height and determine the second negative pressure based on the first negative pressure when a difference between the final target height and the first measurement height is within a predetermined range.

In this case, the controller may be configured to determine a first target height, apply the first negative pressure based on the first target height, and determine the second negative pressure based on a result of comparing the first target height and the first measurement height.

In this case, the controller may control output of the negative pressure application module to be reduced when the first target height is greater than the first measurement height.

In this case, the controller may be configured to increase output of the negative pressure application module when the first target height is greater than the first measurement height.

According to another aspect of the present invention, there is provided a beauty treatment method for elevating a treatment area of a skin by suction, the beauty treatment method including: applying a first negative pressure to the treatment area so that the treatment area is elevated; measuring a first measurement height of the treatment area elevated by the first negative pressure; determining a second negative pressure based on the first measurement height; and applying the second negative pressure to the treatment area.

In this case, the beauty treatment method may further include determining a final target height, in which in the determining of the second negative pressure, when a difference between the final target height and the first measurement height is within a predetermined range, the second negative pressure may be determined based on the first negative pressure.

In this case, the beauty treatment method may further include determining a first target height; and determining the first negative pressure based on the first target height, in which in the determining of the second negative pressure, the second negative pressure may be determined based on a result of comparing the first measurement height and the first target height.

In this case, in the determining of the second negative pressure, the second negative pressure may be determined to be greater than the first negative pressure when the first target height is greater than the first measurement height.

In this case, in the determining of the second negative pressure, the second negative pressure may be determined to be smaller than the first negative pressure when the first target height is greater than the first measurement height.

In this case, the beauty treatment method may further include determining a second target height, in which in the determining of the second negative pressure, the second negative pressure may be determined based on the second target height.

In this case, the beauty treatment method may further include: determining an n-1th target height (n is a natural number equal to or more than 3); applying an n-1th negative pressure to the treatment area for an n-1th; measuring an n-1th measurement height of the treatment area elevated by the n-1th negative pressure; determining an nth target height; determining an nth negative pressure based on the n-1th target height and the n-1th measurement height; and applying the nth negative pressure to the treatment area for an nth, in which the first to nth target heights may gradually increase from the first target height to the nth target height.

### Advantageous Effects

The beauty treatment device and beauty treatment method according to an embodiment of the present invention can produce a predetermined beauty treatment effect on the treatment area and an area adjacent thereto by applying a predetermined negative pressure to the treatment area by the negative pressure application module so that the treatment area is elevated.

In addition, the beauty treatment device and beauty treatment method according to an embodiment of the present invention can minimize side effects due to skin suction while maximizing the beauty treatment effect by having the height measurement sensor measure the height of the treatment area elevated by the negative pressure and the controller determining subsequent negative pressure based on the measured height and controlling the negative pressure application module so that the determined negative pressure is applied.

In addition, the beauty treatment device and beauty treatment method according to an embodiment of the present invention can elevate the treatment area of the skin to the target height without causing sudden deformation of the skin by controlling the negative pressure application module so that the controller determines subsequent negative pressure and applies the determined negative pressure so that the treatment area of the skin is gradually elevated to the final target height.

Effects of the present invention are not limited to the effects described above, and effects not mentioned can be clearly understood by a person skilled in the art from this specification and the attached drawings.

### DESCRIPTION OF DRAWINGS

FIG. 1 is a perspective view of a beauty treatment device according to one embodiment of the present invention. In this case, a head is depicted as transparent so that the inside is visible, and components seen through the head are indicated by dotted lines.

FIG. 2 is an enlarged view of a portion of FIG. 1.

FIG. 3 is a block diagram schematically illustrating a negative pressure application module, a controller, and a height measurement sensor of the beauty treatment device according to one embodiment of the present invention.

FIG. 4 is a view illustrating a state in which the beauty treatment device according to one embodiment of the present invention applies a predetermined negative pressure to a treatment area of a skin. In this case, a cross-section of the head is illustrated so that the inside is visible.

FIG. 5 is a flowchart of a beauty treatment method according to one embodiment of the present invention.

FIG. 6 is a view illustrating a state in which the beauty treatment device controlled by the beauty treatment method according to one embodiment of the present invention elevates the skin. In this case, a first measurement height and a first target height are displayed together.

FIG. 7 is a flowchart of a beauty treatment method according to another embodiment of the present invention.

FIG. 8 is a graph illustrating the relationship between a measurement height of a treatment area that is elevated stepwise and a measurement time by the beauty treatment method according to another embodiment of the present invention.

### BEST MODE

Hereinafter, with reference to the attached drawings, embodiments of the present invention will be described in detail so that those skilled in the art can easily practice the present invention. The present invention may be implemented in various different forms and is not limited to the embodiments described herein. In order to clearly describe the present invention, parts that are not related to the description are omitted in the drawings, and the same reference numerals are assigned to the same or similar components throughout the specification.

The words and terms used in this specification and claims should not be construed as limited to their usual or dictionary meanings, but should be interpreted as having meanings and concepts consistent with the technical idea of the present invention, in accordance with the principles by which the inventor can define terms and concepts in order to best describe his or her invention.

In this specification, it should be understood that terms such as “include” or “have” are intended to describe the presence of a feature, number, step, operation, component, part or combination thereof described in the specification, but do not exclude in advance the possibility of the presence or addition of one or more other features, numbers, steps, operations, components, parts or combinations thereof.

When a component is said to be “in front of”, “behind”, “above”, or “below” another component, unless there are special circumstances, it includes not only being positioned “in front of”, “behind”, “above”, or “below” the other component in direct contact with it, but also cases where there are other components intervening therebetween. Furthermore, when a component is said to be “connected” to another component, unless there are special circumstances, it includes cases where they are indirectly connected to each other as well as cases where they are directly connected to each other.

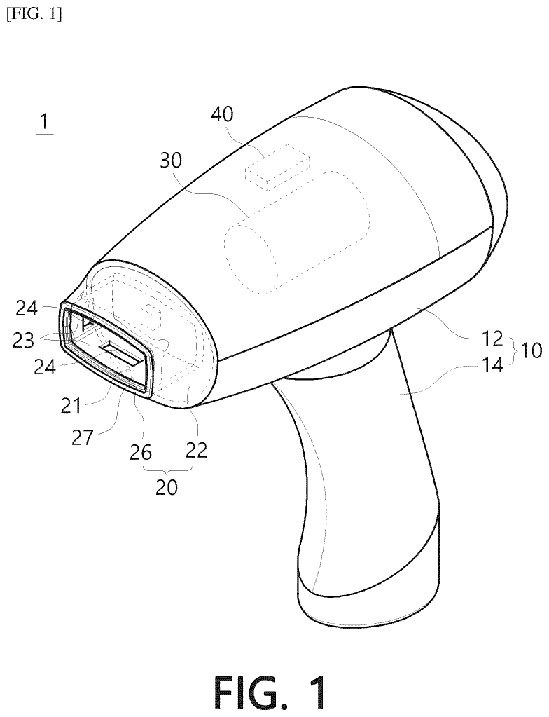

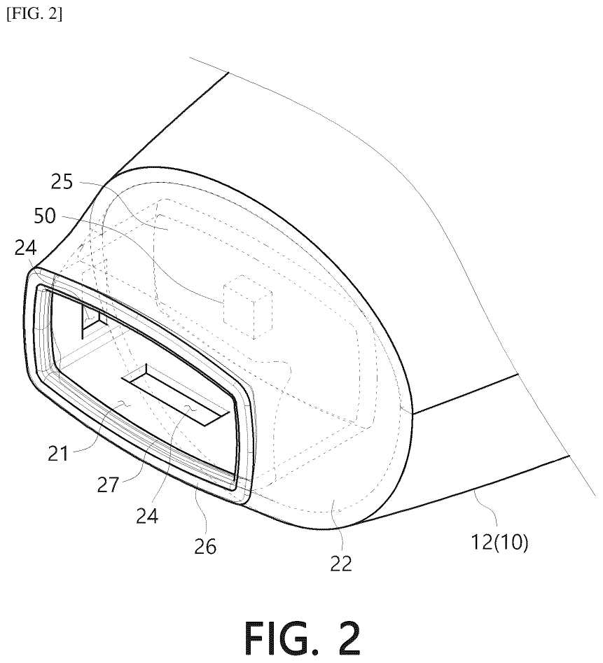

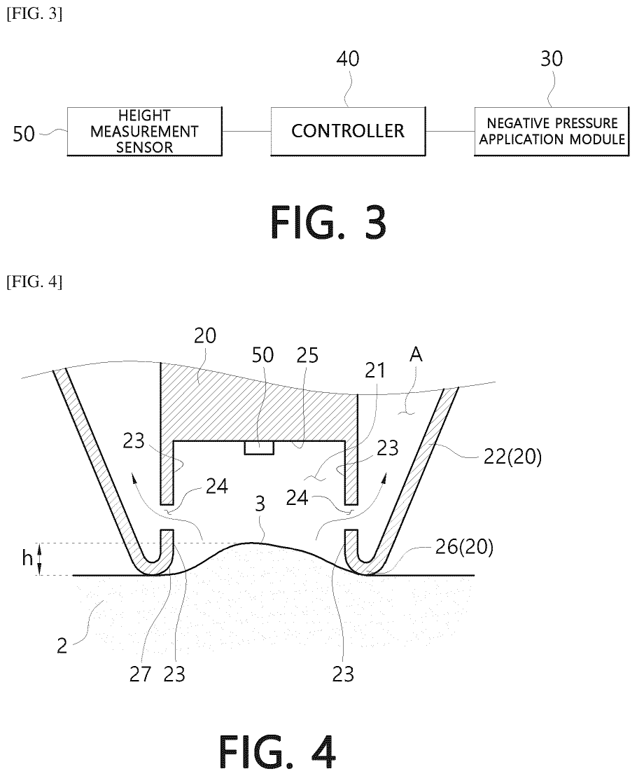

FIG. 1 is a perspective view of a beauty treatment device according to one embodiment of the present invention. In this case, a head is depicted as transparent so that the inside is visible, and components seen through the head are indicated by dotted lines. FIG. 2 is an enlarged view of a portion of FIG. 1. FIG. 3 is a block diagram schematically illustrating a negative pressure application module, a controller, and a height measurement sensor of the beauty treatment device according to one embodiment of the present invention. FIG. 4 is a view illustrating a state in which the beauty treatment device according to one embodiment of the present invention applies a predetermined negative pressure to a treatment area of a skin. In this case, a cross-section of the head is illustrated so that the inside is visible.

Referring to FIGS. 1 to 3, a beauty treatment device 1 according to one embodiment of the present invention may include a main body 10, a head 20, a negative pressure application module 30, a controller 40, and a height measurement sensor 50.

Hereinafter, when explaining with reference to the drawings, a direction in which a suction port 27 of the head 20 of the present beauty treatment device 1 faces is defined as forward, and the opposite direction is defined as rear.

The beauty treatment device 1 according to one embodiment of the present invention is a beauty treatment device that may achieve a predetermined beauty treatment effect, such as a massage, by applying a predetermined negative pressure to the suction port 27 of the head 20 that comes into contact with a skin and thereby elevating the skin toward the inside of the suction port 27. Such application of the negative pressure may be accomplished by the negative pressure application module 30.

In this case, the beauty treatment device 1 according to one embodiment of the present invention is configured such that the height measurement sensor 50 measures the height of the elevated skin to obtain predetermined information. Then, the controller 40 determines an appropriate negative pressure based on the acquired predetermined information, and controls the negative pressure application module 30 based on the predetermined information, so that an appropriate negative pressure is applied to the skin.

Accordingly, according to the beauty treatment device 1 according to one embodiment of the present invention, side effects such as skin damage caused by suction may be minimized while the beauty treatment effect such as massage that the beauty treatment device 1 aims to achieve may be maximized.

Hereinafter, each component of the beauty treatment device according to one embodiment of the present invention will be specifically described.

Referring to FIGS. 1 and 2, the beauty treatment device 1 according to one embodiment of the present disclosure includes the main body 10. The main body 10 may function as a casing for accommodating other components, while also being provided so that a user may hold and operate and control the beauty treatment device 1.

In the present embodiment, the main body 10 may have a cylindrical shape extending forward and backward, and may include a main body portion 12 in which the negative pressure application module 30 and the controller 40 described later are accommodated inside the main body, and a handle portion 14 extending downward from the lower portion of the main body portion 12 so that the user can grasp the beauty treatment device 1.

Although not illustrated, the outer portion of the main body 10 may be provided with a display for indicating the control status of the present beauty treatment device 1, a button member or a touch screen for inputting a signal for controlling the present beauty treatment device 1, or the like. Meanwhile, the shape of the main body 10 is not particularly limited, and may be appropriately changed according to the characteristics of other components accommodated inside, the usage environment, or the like.

Referring to FIGS. 1 and 3, the negative pressure application module 30 may be accommodated inside the main body 10 of the beauty treatment device 1 according to one embodiment of the present invention as described above.

In the present embodiment, the negative pressure application module 30 is configured to generate negative pressure inside the suction port 27 of the head 20 described below, and may be, for example, a pump that can generate negative pressure by sucking air.

In this case, according to one embodiment of the present invention, the negative pressure application module 30 may be configured to control the negative pressure formed by the negative pressure application module 30. In other words, the negative pressure application module 30 may be configured to have variable output.

The negative pressure adjustment of the negative pressure application module 30 may be configured to be controlled by the controller 40 described later. The action according to the negative pressure (or output) adjustment of the negative pressure application module 30 will be described later together with the beauty treatment method according to an embodiment of the present invention.

Meanwhile, the controller 40 may be accommodated inside the main body 10. In this case, the controller 40 may be implemented by a processor, a central processing unit (CPU), a control device, an arithmetic logic unit, an operational logic circuit, a digital signal processing device, a microcomputer, an FPGA, a system on a chip (SoC), a programmable logic unit, a microprocessor, or the like.

According to one embodiment of the present invention, the controller 40 may be configured to be electrically connected to the height measurement sensor 50 described later in addition to the negative pressure application module 30 described above.

In this case, electrically connected in this specification may include not only being electrically connected by an electric line, but also being connected by a known wireless communication method.

Accordingly, the controller 40 according to the present embodiment may be configured to obtain predetermined information from the height measurement sensor 50 and control the negative pressure application module 30 based on the obtained information.

Meanwhile, referring to FIGS. 1 and 2, the head 20 that can come into contact with the skin may be provided in front of the main body portion 12 of the main body 10 of the beauty treatment device 1 according to one embodiment of the present invention.

In this case, referring to FIGS. 1 to 4, the head 20 of the beauty treatment device 1 according to one embodiment of the present invention may include a body portion 22 protruding forward from the main body portion 12 and a contact portion 26 provided at the front end portion of the body portion 22 so as to be in direct contact with the user's skin.

In this case, in the present embodiment, the body portion 22 of the head 20 may have a funnel shape whose diameter decreases as it goes forward. In addition, a treatment space 21 in which a predetermined negative pressure can be formed may be provided inside the body portion 22 of the head 20.

The inner side of the body portion 22 may be provided with a peripheral surface 23 and a bottom surface 25 defining the treatment space 21. The peripheral surface 23 may be formed as a side surface surrounding the treatment space 21 centered on an extension direction of the body portion 22, that is, a front-back direction.

In this case, as illustrated in FIG. 4, an internal space A surrounded by the outer side of the body portion 22 and the peripheral surface 23 of the body portion 22 may be provided inside the body portion 22. This internal space A may be connected to the inside of the main body 10 equipped with the negative pressure application module 30.

Moreover, a plurality of negative pressure holes 24 may be formed on the peripheral surface 23. The negative pressure holes 24 may perform the function of fluidically connecting the treatment space 21 and the negative pressure application module 30 so that negative pressure is formed in the treatment space 21. Of course, the negative pressure holes 24 may also be formed on the bottom surface 25 described below.

Accordingly, according to the present embodiment, the internal air of the treatment space 21 is sucked into the negative pressure hole 24 by the negative pressure application module 30, so that negative pressure may be formed in the treatment space 21.

Meanwhile, referring again to FIGS. 1 and 2, in the present embodiment, the bottom surface 25 defining the rear surface of the treatment space 21 may be formed at the rear of the treatment space 21. The height measurement sensor 50 described below may be installed on the bottom surface 25.

Although not illustrated, a stimulation generator may be additionally provided on the peripheral surface 23 or the bottom surface 25 as a configuration capable of applying a predetermined cosmetic stimulus. For example, a light source capable of irradiating an intense pulsed light (IPL) laser or a high-frequency generator capable of applying radio frequency (RF) high frequency may be provided. Accordingly, the beauty treatment device 1 may be capable of performing additional beauty treatments by the above configuration.

Again, referring to FIGS. 1 and 2, in one embodiment of the present invention, the suction port 27 may be formed at the front end portion of the body portion 22 of the head 20. In addition, the contact portion 26 may be provided around the suction port 27. In this case, the contact portion 26 may include a forward convex curved surface to minimize skin damage upon contact.

According to one embodiment of the present invention, the suction port 27 may be configured to be connected to the treatment space 21 of the body portion 22. Accordingly, the treatment space 21 may be communicated with the outside through the suction port 27, and when negative pressure is formed in the treatment space 21, skin may be sucked into the treatment space 21 through the suction port 27.

Meanwhile, the shape and structure of the head 20 described in relation to one embodiment of the present invention are not particularly limited, and the head 20 may be formed in various shapes capable of applying the negative pressure formed by the negative pressure application module 30 to a local part of the skin.

Furthermore, in the present embodiment, the main body 10 and the head 20 are illustrated as being provided as separate configurations, but the main body 10 and the head 20 may be provided as a single unit if necessary.

Referring to FIGS. 2 and 3, according to one embodiment of the present invention, the head 20 may be equipped with the height measurement sensor 50 as described above. The height measurement sensor 50 is configured to measure the height of the skin elevated toward the inside of the suction port 27 and the treatment space 21.

For this purpose, the height measurement sensor 50 may be installed on the bottom surface 25 of the body portion 22 of the head 20 so as to face the suction port 27, that is, the front. However, the position of the height measurement sensor 50 is not particularly limited, and the height measurement sensor 50 may be installed on the outer side of the head 20 as long as it can measure the height of the elevated skin.

In addition, the height measurement sensor 50 may be formed of a proximity sensor or an light sensor, but is not limited thereto, and the height measurement sensor 50 may have various known configurations capable of measuring the height of the elevated skin.

Referring to FIG. 4 together, the height of an elevated skin 2 measured by the height measurement sensor 50, that is, the height of the treatment area 3, may be appropriately defined as needed. For example, the height of the elevated treatment area 3 may be the height of the uppermost portion of the elevated treatment area 3. Alternatively, the height of the elevated treatment area 3 may be an average height of the elevated treatment area 3.

In this way, the height of the elevated treatment area 3 may be appropriately defined in consideration of the effect of the beauty treatment that the beauty treatment device 1 is intended to achieve, and the height measurement sensor 50 may be configured to be suitable for measuring the height of the elevated treatment area 3 that is defined.

Hereinafter, in explaining the beauty treatment device and the beauty treatment method according to one embodiment of the present invention, it will be explained on the premise that the height of the elevated treatment area 3 is defined as a height h from the contact portion 26 of the head 20 to the uppermost portion of the elevated treatment area 3.

Hereinafter, with reference to FIG. 4, a process of performing the beauty treatment using the beauty treatment device according to one embodiment of the present invention will be briefly described.

Referring to FIGS. 3 and 4, the user may place the head 20 of the beauty treatment device 1 according to one embodiment of the present invention so as to come into contact with the surface of the skin 2. Accordingly, the treatment area 3 of the skin 2 may be placed adjacent to the suction port 27 of the contact portion 26 of the head 20.

Thereafter, the user may input a signal to command the operation of the controller 40 of the beauty treatment device 1. Accordingly, the controller 40 of the beauty treatment device 1 according to one embodiment of the present invention may start controlling the negative pressure application module 30.

When the controller 40 may control the negative pressure application module 30 to apply negative pressure to the suction port 27 and the treatment space 21, air in the treatment space 21 may be sucked into the internal space A provided between the outer portion of the body portion 22 of the head 20 and the peripheral surface 23 through the negative pressure hole 24 of the head 20.

As air is sucked in, negative pressure may be formed in the suction port 27 and the treatment space 21, and the treatment area 3 of the skin 2 may be elevated convexly inwardly toward the suction port 27 and the treatment space 21 due to the negative pressure.

In this case, the height measurement sensor 50 may measure the height at which the treatment area 3 is elevated. Then, the controller 40 may control the negative pressure application module 30 using the information measured by the height measurement sensor 50.

Through the above-described process, the beauty treatment device 1 according to one embodiment of the present invention may produce a predetermined beauty treatment effect, such as a massage through suction, on the skin 2.

Hereinafter, the beauty treatment method according to an embodiment of the present invention that may be implemented as the beauty treatment device according to one embodiment of the present invention by using different drawings will be described.

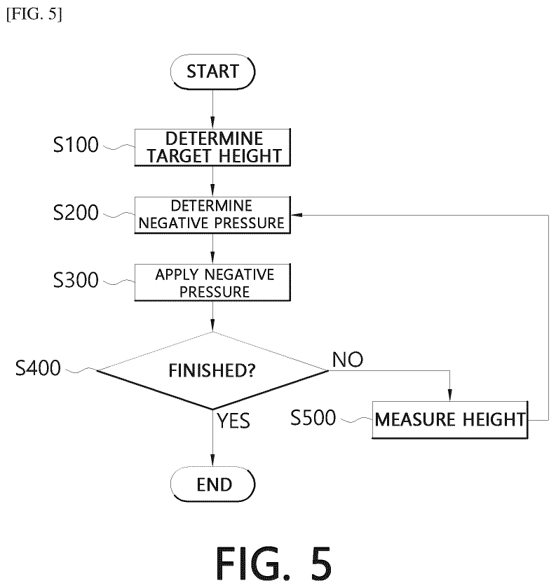

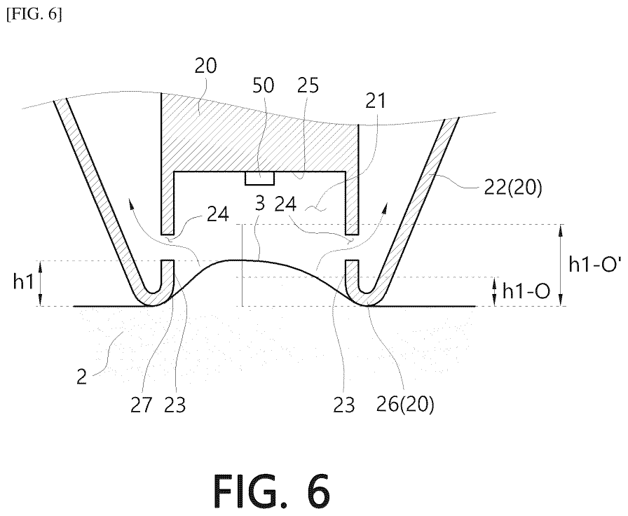

FIG. 5 is a flowchart of a beauty treatment method according to one embodiment of the present invention. FIG. 6 is a view illustrating a state in which the beauty treatment device controlled by the beauty treatment method according to one embodiment of the present invention elevates the skin. In this case, a first measurement height and a first target height are displayed together.

Referring to FIGS. 3 to 6, in the beauty treatment method according to one embodiment of the present invention, the user may input a signal to start the beauty treatment to the controller 40 of the beauty treatment device 1. Accordingly, the controller 40 may start the beauty treatment.

In this case, the user may input information that can indicate the characteristics of the user's skin, such as information about the user's age, gender, presence of a specific disease, or the like (hereinafter referred to as “user information”) into the controller 40 together with the start signal.

In the present embodiment, the controller 40 sets the first target height as the first step of the beauty treatment (S100). In this case, the first target height is the height of the treatment area 3 that the beauty treatment device 1 intends to elevate by applying the first negative pressure described below. That is, the first target height may be information for the first negative pressure.

This first target height may be a value input from the outside by a user or the like, a value stored in advance in a separate storage location provided in the controller 40, or a value calculated through a predetermined formula or data table based on the user information.

Moreover, in the present embodiment, the controller 40 determines the first negative pressure based on the first target height (S200). In this case, determining the negative pressure may mean determining the intensity (or size) of the negative pressure.

In the present embodiment, the first negative pressure determined in the negative pressure determination step (S200) may be a value stored in a separate storage location provided in the controller 40, or may be a value calculated through a predetermined formula or database based on the user information or the first target height.

According to the present embodiment, the first negative pressure may be determined to have an intensity suitable for elevating the treatment area 3 to a height corresponding to the first target height. However, the intensity of the appropriate negative pressure may vary depending on the skin condition of the user. Therefore, as an example, the intensity of the first negative pressure may be determined to be a general (or average) value.

Moreover, in the present embodiment, the controller 40 controls the negative pressure application module 30 so that the determined first negative pressure is applied to the treatment area 3 (S300). In other words, the controller 40 may control the output of the negative pressure application module 30 so that the first negative pressure is applied to the treatment area 3.

Accordingly, as illustrated in FIG. 4, the treatment area 3 of the skin 2 is elevated toward the inside of the treatment space 21 through the suction port 27, and the beauty treatment effect such as a massage by suction, may be generated at the treatment area 3.

Moreover, in the present embodiment, the controller 40 determines whether the beauty treatment is finished (S400).

In this case, the criteria for determining whether the controller 40 has finished the beauty treatment may be configured in various ways. For example, the criteria may be whether an input signal for the user to finish the beauty treatment has been received by the controller 40. Alternatively, the criteria may be whether the total amount of energy applied to the treatment area 3 by suction has reached a specific value. Here, the specific value may be a preset value or a value input by the user to the controller 40.

When the controller 40 determines that the beauty treatment will not be terminated (S400), in the present embodiment, the height measurement sensor 50 measures the elevated height of the treatment area 3 (S500). Then, the height measurement sensor 50 transmits information about the elevated height to the controller 40. Hereinafter, the height of the treatment area 3 elevated by the first negative pressure measured by the height measurement sensor 50 is referred to as a first measurement height h1.

Moreover, in the present embodiment, the controller 40 sets the target height again (S100). Here, the target height set again is a second target height. In this case, the second target height may be information for the second negative pressure, as discussed above with respect to the first target height.

Meanwhile, referring to FIGS. 3 to 6, in the step (S100) of setting the second target height, the controller 40 may set the second target height based on the result of comparing first target heights h1-O and h1-O′ and the first measurement height h1.

Through this, the beauty treatment method according to the present embodiment may perform the beauty treatment suitable for the user by taking into consideration the user's skin condition, such as skin elasticity.

As illustrated in FIG. 6, there may be a case where the first measurement height h1 of the treatment area 3 elevated by the first negative pressure is greater than the first target height h1-O. This may mean that the user's skin elasticity is lower than the general (or average) level.

Considering this, in step S100, the controller 40 may set the second target height to be smaller than the first target height when the first measurement height h1 is greater than the first target height h1-O. This is because, since the skin can be easily deformed due to low skin elasticity, side effects such as skin damage due to excessive skin elevation may occur.

Alternatively, taking this into account, in step S100, the controller 40 may set the second target height to be greater than the first target height when the first measurement height hl is greater than the first target height h1-O. This is because, since the amount of stimulation applied according to deformation may be small due to low skin elasticity, it may be necessary to elevate the skin higher with a stronger negative pressure to achieve the target beauty treatment effect.

Conversely, as illustrated in FIG. 6, there may be a case where the first measurement height h1 of the treatment area 3 elevated by the first negative pressure is smaller than the first target height h1-O'. This may mean that the user's skin elasticity is higher than the general (or average) level.

Considering this, in step S100, the controller 40 may set the second target height to be smaller than the first target height when the first measurement height h1 is smaller than the first target height h1-O'. This is because, when suction is performed with a stronger negative pressure to elevate the treatment area 3 to a higher height, side effects such as bruising may occur due to strong resistance of the skin.

Alternatively, taking this into account, in step S100, the controller 40 may set the second target height to be greater than the first target height when the first measurement height h1 is less than the first target height h1-O'. This is because, in order to achieve the target beauty treatment effect, it may be necessary to elevate the skin higher with a stronger negative pressure.

In this way, according to the beauty treatment method according to the present embodiment, the subsequent target height may be appropriately set depending on the user's skin condition and situation.

In addition, in the present embodiment, the controller 40 determines the negative pressure again (S200). Here, the negative pressure determined again is a second negative pressure. In this case, according to the present embodiment, the second negative pressure may be a value stored in a separate storage location provided in the controller 40, as discussed above with respect to the first negative pressure, or may be a value calculated through a predetermined formula or database based on user information or the second target height.

Further, this second negative pressure may be determined to have an intensity suitable for elevating the treatment area 3 to the height corresponding to the second target height. However, the intensity suitable for each user may vary. Therefore, as an example, the intensity of the second negative pressure may be determined as a general (or average) value.

In this case, when the second target negative pressure is greater than the first target negative pressure, it is preferable that the intensity of the second negative pressure is greater than the intensity of the first negative pressure. Furthermore, when the second target negative pressure is smaller than the first target negative pressure, it is preferable that the intensity of the second negative pressure is smaller than the intensity of the first negative pressure.

In this way, according to the beauty treatment method according to the present embodiment, the negative pressure to be applied subsequently may be appropriately determined depending on the user's skin condition and situation.

Moreover, in the present embodiment, the controller 40 controls the negative pressure application module 30 so that negative pressure is applied to the treatment area 3 again (S300). Here, the negative pressure applied to the treatment area 3 is the second negative pressure determined in advance. Accordingly, according to the beauty treatment method according to the present embodiment, subsequent negative pressure may be appropriately applied according to the user's skin condition and situation.

Moreover, in the present embodiment, the controller 40 determines again whether the beauty treatment is finished.

Thus, according to one embodiment of the present invention, the controller 40 may repeatedly perform the step (S500) of measuring the elevated height of the treatment area 3 by the height measurement sensor 50, the step (S200) of determining the negative pressure to be applied subsequently based on the measurement height by the controller 40, and the step (S330) of applying the determined negative pressure before determining that the beauty treatment is finished at step S500.

In this way, according to the beauty treatment method according to one embodiment of the present invention, by controlling the negative pressure application module 30 so that negative pressure is applied appropriately to the user's skin using the height measurement sensor 50 and a timer 60, the side effects may be minimized while maximizing the effect of the beauty treatment.

Hereinafter, a beauty treatment method according to another embodiment of the present invention will be described.

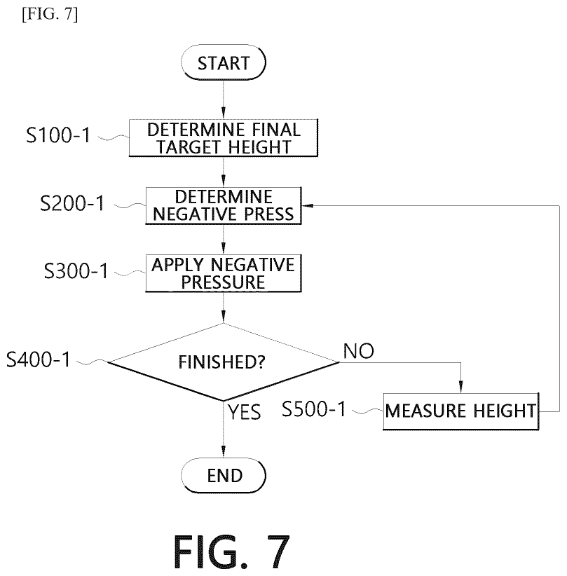

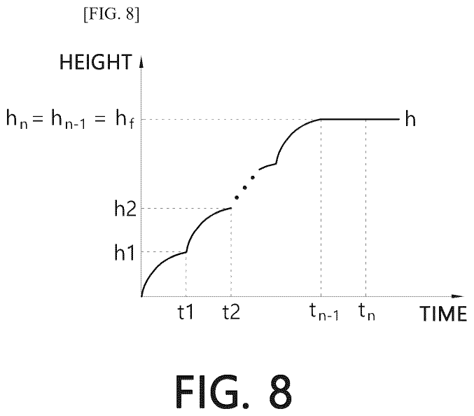

FIG. 7 is a flowchart of a beauty treatment method according to another embodiment of the present invention. FIG. 8 is a graph illustrating the relationship between a measurement height of a treatment area that is elevated stepwise and a measurement time by the beauty treatment method according to another embodiment of the present invention.

The beauty treatment method according to another embodiment of the present invention relates to a beauty treatment method capable of minimizing side effects due to suction and maximizing the effect of the beauty treatment during a process in which the treatment area is elevated to a predetermined height.

Referring to FIGS. 3, 4, 7 and 8, as in the previous embodiment, the user may input a signal to start the beauty treatment and the user information into the controller 40 in a predetermined manner. Accordingly, the controller 40 may start the beauty treatment.

In the present embodiment, the controller 40 determines a final target height hf (S100-1). Here, the final target height hf may be the height of the treatment area 3 that is ultimately to be elevated through the beauty treatment.

This final target height hf may be determined based on data previously stored in a separate storage location. Alternatively, the final target height hf may be determined based on a value input by the user. Alternatively, the final target height hf may be determined using a predetermined formula or data table based on user information, or the like.

Moreover, in the present embodiment, the controller 40 determines the first negative pressure (S200-1). In this case, the first negative pressure may be determined by a signal input from the outside by a user or the like. Alternatively, the first negative pressure may be determined based on data previously stored in a separate storage location. Alternatively, the first negative pressure may be determined using a predetermined formula or data table based on user information or the final target height hf.

In this case, since the intensity of the first negative pressure is the starting stage of the beauty treatment, it is desirable to have a lower intensity than the strongest negative pressure applied in the beauty treatment. Accordingly, side effects due to sudden skin deformation may be prevented.

Furthermore, in the present embodiment, the controller 40 applies the determined first negative pressure to the treatment area 3 of the skin 2 (S300-1). Accordingly, the treatment area 3 is elevated toward the inside of the treatment space 21 through the suction port 27, and a predetermined beauty treatment effect may be generated in the treatment area 3 and the area adjacent thereto.

Moreover, in the present embodiment, the controller 40 determines whether the beauty treatment is finished (S400-1). When the controller 40 determines that the beauty treatment is not finished (S400-1), in the present embodiment, the height measurement sensor 50 measures the elevated first measurement height h1 of the treatment area 3 (S500-1).

Moreover, in the present embodiment, the controller 40 determines the negative pressure again (S200-1). Here, the negative pressure to be determined is a second negative pressure applied subsequent to the first negative pressure. In this case, according to the present embodiment, the controller 40 may compare the final target height hf and the first measurement height h1 to determine the second negative pressure.

The controller 40 may determine that the second negative pressure is greater than the first negative pressure when the difference between the final target height hf and the first measurement height h1 is outside a predetermined range. In this case, the predetermined range may be appropriately set within a range that may be cited according to the characteristics of the beauty treatment device 1, the usage environment, or the like, taking into account that the measurement height and the final target height hf may not be completely identical.

In this case, the difference between the second pressure and the first pressure, that is, the increase in negative pressure, may be determined based on data stored in a separate storage space. Alternatively, the increase in negative pressure may be determined using a predetermined formula or data table based on the user information or the final target height hf.

Moreover, in the present embodiment, the controller 40 controls the negative pressure application module 30 again so that negative pressure is applied to the treatment area 3 (S300-1). In this case, the negative pressure applied is the second negative pressure determined in advance.

In addition, in the present embodiment, the controller 40 determines again whether the beauty treatment is finished (S400-1), and when it is determined that the beauty treatment is not finished, the elevated height of the treatment area 3 is measured again (S500-1). In this case, the measurement height becomes the second measurement height h2 of the treatment area 3 elevated by the second negative pressure.

In the present embodiment, the controller 40 may repeatedly perform steps S100-1 to S500-1 described above until it is determined to finish the beauty treatment in the termination determination step (S400-1).

In this case, as illustrated in FIG. 8, while repeatedly performing the above-described steps S100-1 to S500-1, an n-1th negative pressure may be applied to the treatment area 3 for an n-1th. Then, an n-1th measurement height hn-1 of the treatment area 3 to which the n-1th negative pressure is applied may be measured.

In this case, according to the present embodiment, in the negative pressure determination step (S200-1), the controller 40 may determine the nth negative pressure based on the n-1th negative pressure when the difference between the n-1th measurement height hn-1 and the final target height hf is within a predetermined range. For example, the controller 40 may determine the nth negative pressure to be the same as the n-1th negative pressure.

Moreover, the controller 40 may apply the determined nth negative pressure to the treatment area 3. Accordingly, as illustrated in FIG. 9, the elevated height h of the treatment area 3 may be maintained at a predetermined value.

More specifically, the nth measurement height hn may be substantially equal to the n-1th measurement height hn-1 within a quotable range. In this case, the nth measurement height hn is a height obtained by measuring the treatment area 3 elevated by the nth negative pressure.

In this way, according to the present embodiment, since the treatment area 3 is elevated stepwise to the final target height hf, the treatment area 3 can be elevated to the final target height hf without causing sudden deformation of the skin.

Through this, the beauty treatment method according to the present embodiment may achieve the target beauty treatment effect while minimizing side effects such as skin damage that may occur due to sudden skin deformation.

Meanwhile, in the beauty treatment method according to one embodiment of the present invention, as described in the beauty treatment method according to another embodiment of the present invention, the final target height may be set. In other words, the first target height and the final target height may be set together.

In addition, the beauty treatment method according to an embodiment of the present invention may be implemented by the beauty treatment device according to one embodiment of the present invention described above. However, the beauty treatment method according to an embodiment of the present invention may be implemented by various devices that can apply negative pressure to elevate skin to achieve a predetermined treatment effect, in addition to the beauty treatment device according to one embodiment of the present invention.

Although one embodiment of the present invention has been described above, the spirit of the present invention is not limited to the embodiment presented in this specification, and those skilled in the art who understand the spirit of the present invention will be able to easily suggest other embodiments by adding, changing, deleting, or adding components within the scope of the same spirit, but this will also be considered to fall within the spirit of the present invention.

1. A beauty treatment device comprising:
a main body;
a head including a body portion that protrudes outwardly from the main body and a contact portion that is provided at an end portion of the body portion so as to come into contact with a skin and has a suction port formed therein;
a negative pressure application module that is provided inside the main body so as to apply a negative pressure for elevating a treatment area of the skin to the suction port;
a height measurement sensor that measures a height of the treatment area elevated by the negative pressure; and
a controller that is electrically connected to the negative pressure application module and the height measurement sensor,
wherein the controller controls the negative pressure application module so that a first negative pressure is applied to the suction port, and controls the negative pressure application module so that a second negative pressure determined based on a first measurement height of the treatment area elevated by the first negative pressure is applied to the suction port.

2. The beauty treatment device of claim 1, wherein the controller is configured to determine a final target height and determine the second negative pressure based on the first negative pressure when a difference between the final target height and the first measurement height is within a predetermined range.

3. The beauty treatment device of claim 1, wherein the controller controls the determination of a first target height, the application of the first negative pressure based on the first target height, and the determination of the second negative pressure based on a result of comparing the first target height and the first measurement height.

4. The beauty treatment device of claim 3, wherein the controller controls output of the negative pressure application module to be reduced when the first target height is greater than the first measurement height.

5. The beauty treatment device of claim 3, wherein the controller is configured to increase output of the negative pressure application module when the first target height is greater than the first measurement height.

6. A beauty treatment method for elevating a treatment area of a skin by suction, the beauty treatment method comprising:
applying a first negative pressure to the treatment area so that the treatment area is elevated;
measuring a first measurement height of the treatment area elevated by the first negative pressure;
determining a second negative pressure based on the first measurement height; and
applying the second negative pressure to the treatment area.

7. The beauty treatment method of claim 6, further comprising determining a final target height,
wherein in the determining of the second negative pressure, when a difference between the final target height and the first measurement height is within a predetermined range, the second negative pressure is determined based on the first negative pressure.

8. The beauty treatment method of claim 6, further comprising:
determining a first target height; and
determining the first negative pressure based on the first target height,
wherein in the determining of the second negative pressure, the second negative pressure is determined based on a result of comparing the first measurement height and the first target height.

9. The beauty treatment method of claim 8, wherein in the determining of the second negative pressure, the second negative pressure is determined to be greater than the first negative pressure when the first target height is greater than the first measurement height.

10. The beauty treatment method of claim 9, wherein in the determining of the second negative pressure, the second negative pressure is determined to be smaller than the first negative pressure when the first target height is greater than the first measurement height.

11. The beauty treatment method of claim 8, further comprising determining a second target height,
wherein in the determining of the second negative pressure, the second negative pressure is determined based on the second target height.

12. The beauty treatment method of claim 11, further comprising:
determining an n-1th target height (n is a natural number equal to or more than 3);
applying an n-1th negative pressure to the treatment area for an n-1th;
measuring an n-1th measurement height of the treatment area elevated by the n-1th negative pressure;
determining an nth target height;
determining an nth negative pressure based on the n-1th target height and the n-1th measurement height; and
applying the nth negative pressure to the treatment area for an nth,
wherein the first to nth target heights gradually increase from the first target height to the nth target height.
